(19) United States
(12) Patent Application Publication
(10) Pub. No.: US 2025/0290943 A1
(43) Pub. Date: Sep. 18, 2025

(54) THERMAL TESTING SYSTEM

(71) Applicant: Teradyne, Inc., North Reading, MA (US)

(72) Inventor: Michael J. Drolette, Manchester, NH (US)

(73) Assignee: Teradyne, Inc., North Reading, MA (US)

(21) Appl. No.: 18/604,873

(22) Filed: Mar. 14, 2024

(51) Int. Cl. G01N 35/04; G01N 25/00; G01N 35/00

(52) U.S. Cl. CPC G01N 35/04; G01N 25/00; G01N 2035/00346

(57) ABSTRACT

An example test system includes a test site configured to mate to a carrier, where the carrier contains a device under test (DUT) to be tested at the test site; a transition rack that includes slots, where a slot is configured to mate to the carrier, where the transition rack and the carrier mated to the slots are in thermal communication with a thermal controller, and where the thermal controller is for controlling a temperature of the DUT; and a gantry system to move the carrier between the transition rack and the test site. An enclosure contains the test site, the transition rack, and the gantry system. The enclosure is configured to complement temperature control of the carrier and the DUT contained therein by the thermal controller. A test instrument is configured to communicate with the DUT in the carrier in the test site to test the DUT.

### TECHNICAL FIELD

This specification describes example implementations of systems and processes for performing thermal testing on a device.

### BACKGROUND

A test system is configured to test the operation of a device. A device tested by a test system is referred to as a device under test (DUT). System-level testing (SLT) involves testing an entire DUT, rather than individual components of the DUT. If the DUT passes a battery of system-level tests, it is assumed that the individual components of the device are operating properly. SLT may include thermal testing. Thermal testing may include changing the temperature of the DUT and then performing system-level or other tests on the DUT at the changed temperature. In some test systems, thermal testing may be performed to test the DUT over a range of different temperatures.

### SUMMARY

An example test system includes a test site configured to mate to a carrier, where the carrier contains a device under test (DUT) to be tested at the test site; a transition rack that includes slots, where a slot is configured to mate to the carrier, where the transition rack and the carrier mated to the slots are in thermal communication with a thermal controller, and where the thermal controller is for controlling a temperature of the DUT; and a gantry system to move the carrier between the transition rack and the test site. An enclosure contains the test site, the transition rack, and the gantry system. The enclosure is configured to complement temperature control of the carrier and the DUT contained therein by the thermal controller. A test instrument is configured to communicate with the DUT in the carrier in the test site to test the DUT. The example test system may include one or more of the following features, either alone or in combination.

The enclosure and/or an assembly that includes the enclosure may include a material or has a mass that complements temperature control of the DUT. The test instrument may be within a range of 0.1 to 1.5 meters from the test site. The test instrument may include a test channel between the test instrument and the test site. The test channel may include a wired or wireless channel and may be within the range. The test channel between the test instrument and the test site may be direct and include no switches. Within the range, there may be an improvement in signal insertion loss of 50% or greater for test frequencies of up to 40 gigahertz (GHz). The test channel may include fewer than sixteen interconnects between the test instrument and the test site.

When mated, the carrier may hang from the slot in the transition rack. The test site may include a shelf to hold the carrier and an actuator to extend the shelf to receive the carrier and to retract the shelf to mate the carrier to the test site. The gantry system may be configured to move each carrier in three dimensions. The test system may include a control system configured (i) to control the gantry system to move the carrier from the transition rack to the test site for testing, (ii) to control the gantry system to move the carrier from the test site to the transition rack following testing, (iii) to control the thermal controller to change a temperature of the DUT, and (iv) to control the gantry system to move the carrier from the transition rack to the test site for testing following the change in temperature.

The enclosure may include an input to receive the carrier. The test system may include a conveyor to move the carrier relative to the input. The gantry system may be controllable to move the carrier between the input and the transition rack. The test system may include robotics to move the carrier to and from the conveyor.

The test system may include the thermal controller. The thermal controller may include a convective cooling device or a heating device. The thermal controller may be configured to mate to, and to detach from, the enclosure.

The test site may include roller bearings and an interlock. The roller bearings and the interlock may be for enabling the carrier to mate to the test site.

The test instrument may be configured to communicate with the DUT over a cable connection. The cable connection may include a connector at the enclosure. The connector may be insulated and sealed.

Controlling the temperature may include decreasing the temperature relative to ambient temperature outside of the enclosure. Controlling the temperature may include increasing the temperature relative to ambient temperature outside of the enclosure.

The test system may include a control system configured to assign each carrier an identifier and to track movement of the carrier throughout the test system based on the identifier.

Any two or more of the features described in this specification, including in this summary section, may be combined to form implementations not specifically described in this specification.

At least part of the devices, systems, techniques, and processes described in this specification may be implemented or controlled by executing, on one or more processing devices, instructions that are stored on one or more non-transitory machine-readable storage media. Examples of non-transitory machine-readable storage media include read-only memory, an optical disk drive, memory disk drive, and random access memory. At least part of the devices, systems, techniques, and processes described in this specification may be implemented or controlled using a computing system comprised of one or more processing devices and memory storing instructions that are executable by the one or more processing devices to perform various control operations. The devices, systems, techniques, and processes described in this specification may be configured, for example, through design, construction, composition, arrangement, placement, programming, operation, activation, deactivation, and/or control.

The details of one or more implementations are set forth in the accompanying drawings and the following description. Other features and advantages will be apparent from the description and drawings, and from the claims.

### DESCRIPTION OF THE DRAWINGS

FIG. 1 is a diagram showing a perspective view of an example test system.

FIG. 2 is a diagram showing a perspective view of the example test system of FIG. 1 with its front door open.

FIG. 3 is a diagram showing a side view of the example test system of FIG. 1 with its front door open.

FIG. 4 is a diagram showing a partially-transparent, perspective view of components of the example test system of FIG. 1.

FIG. 5 is a diagram showing a cut-away, perspective view of example components in a variant of the example test system of FIG. 1.

FIG. 6 is a diagram showing a perspective view of an example carrier that may be used in the test system of FIGS. 1 to 6.

FIG. 7 is a diagram showing a perspective view of an example test site that may be part of the test system of FIGS. 1 to 6.

FIG. 8 is a diagram showing a perspective view of the example test site of FIG. 7 containing a carrier.

FIG. 9 is a block diagram of components of an example gantry system that may be part of the test system of FIGS. 1 to 6.

FIG. 10 is a flowchart showing example operations included in an example process for performing system level testing on a device under test in a carrier.

Like reference numerals in different figures indicate like elements.

### DETAILED DESCRIPTION

Described herein are examples of systems and processes for performing system-level thermal tests on a device, which may be referred to as either the device under test (DUT) or unit under test (UUT). System-level thermal testing may including changing the temperature of the DUT and then performing system-level tests on the DUT at the changed temperature. The temperature of the DUT may be changed multiple times and system-level testing may be performed at multiple different temperatures. Examples of devices that may be tested include, but are not limited to, circuit boards, consumer electronics such as smartphones, and individual electronic components.

Examples of system-level tests that may be performed include functional tests. Functional tests may include running a device's general functions and target applications and verifying that they work as expected. These operations can include starting chips, loading an operating system, and/or running specific programs, such as performance evaluation programs. Functional testing may include determining if an operation of a device was successful based on test results, such as comparison of a test result to a threshold and/or the success or failure of an operation.

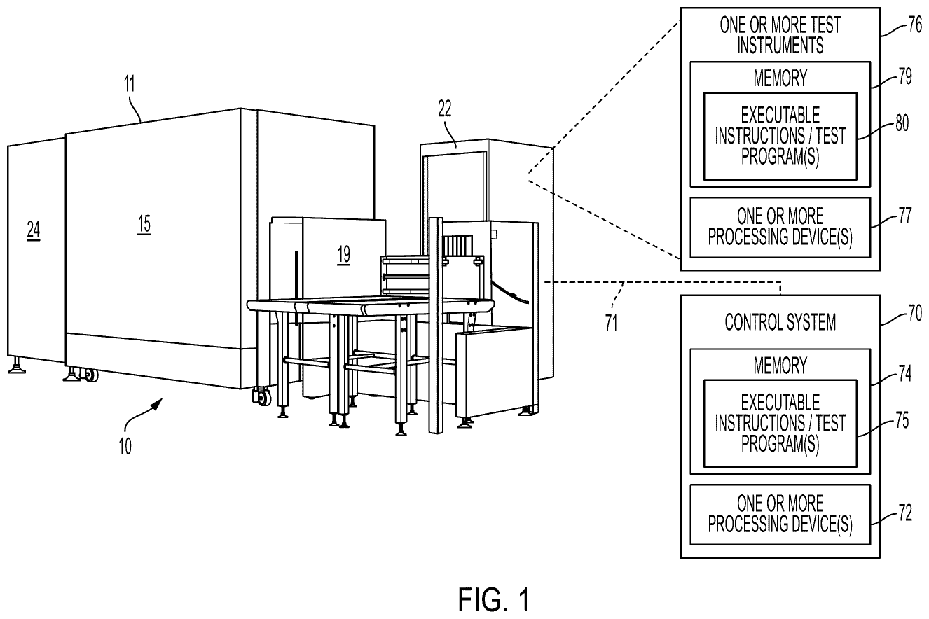

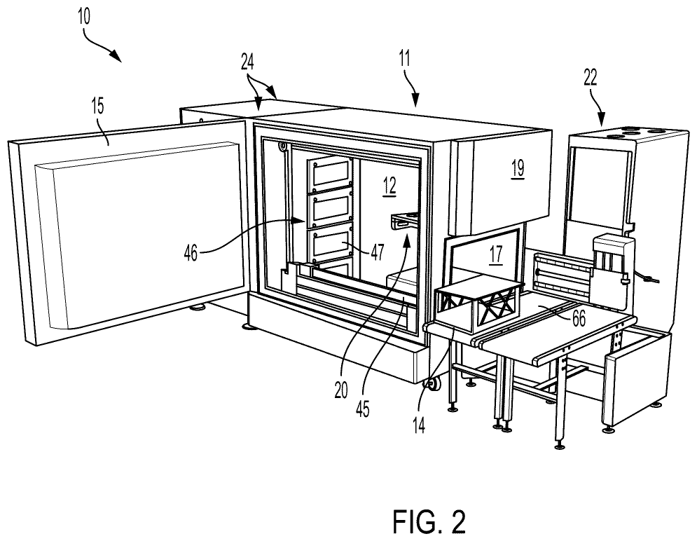

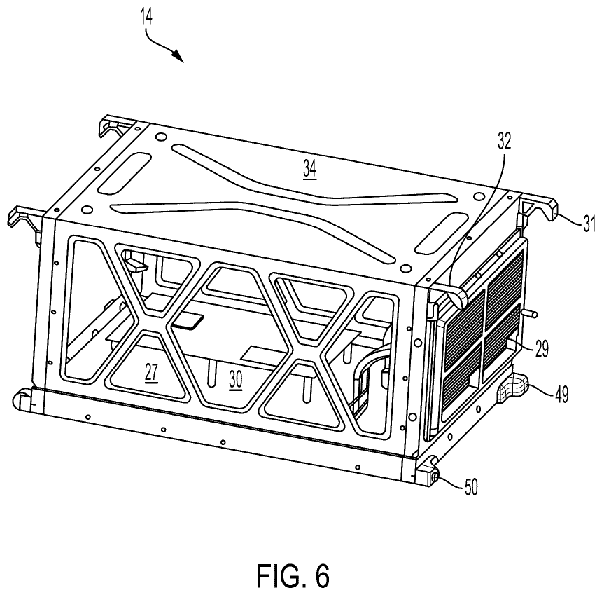

FIGS. 1 to 5 show components of an example test system 10 configured to perform system-level thermal testing on devices. The components include an enclosure 11. Enclosure 11 includes an environmentally-controlled interior 12 that contains components of test system 10, including one or more carriers, which are collectively labeled 14 (see also FIG. 6), and which each hold one or more DUTs to be tested by the test system. Enclosure 11 includes a door 15 that is openable and closeable to access interior 12. For example, door 15 may be on hinges and opened and closed manually or automatically using a motor that is controlled based on a signal from a control system (described below). Enclosure 11 also includes a entry/exit 17 to receive carriers containing DUT(s) for testing and to allow carriers containing DUT(s) that have been tested to exit enclosure 11. Entry/exit 17 may be open as shown in FIG. 2 or blocked as shown in FIG. 1 through movement of door 19. In some implementations, door 19 may be mounted on tracks and opened and closed manually or automatically using one or more actuators controlled by a motor that is controlled by the control system.

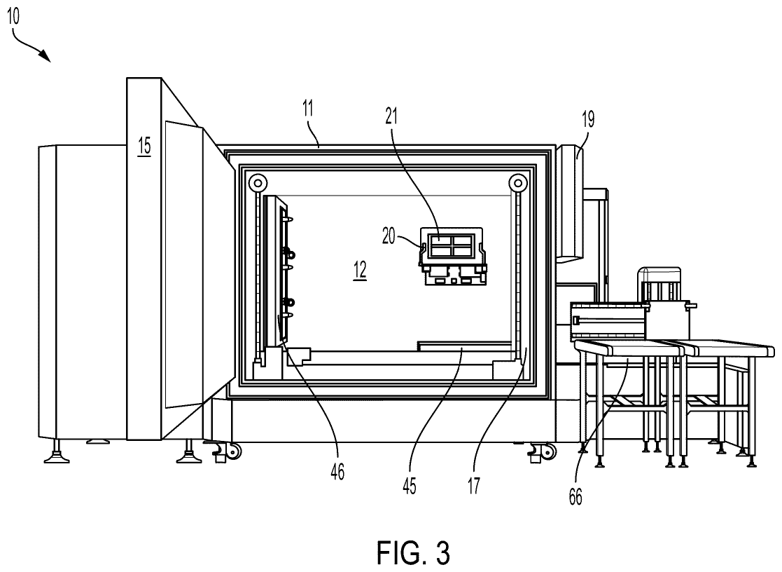

A test site 20 within enclosure 11 (see FIGS. 3 to 5, 7, and 8) may include one or more connectors 21 configured to connect to electrical wires and/or cables and/or optical wires and/or cables from a test station 22, which is described below. The test site may be located at any appropriate location within enclosure 11. Each of these connectors 21 may be insulated and sealed/air-tight. For reasons explained below, in some implementations, test site 20 is located as closely as possible within enclosure 11 to a test instrument or instruments, which may reside within test station 22 and which test DUT(s) in a carrier connected to the test site.

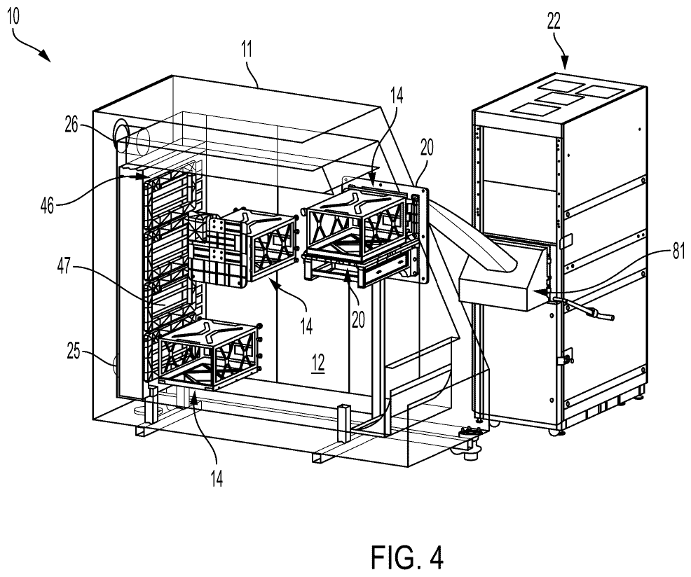

Enclosure 11 includes one or more input ports 25 (see FIG. 4) to receive conditioned air from a thermal controller 24 (see, e.g., FIG. 1) and one or more output ports 26 (see FIG. 4) to move air from enclosure 11 to thermal controller 24, thereby creating air circulation between thermal controller 24 and enclosure 11. In some implementations, the one or more input ports 25 may be at or near a bottom of enclosure 11 and the one or more output ports 26 may be at or near a top of enclosure 11. This arrangement may be beneficial when cooling DUTs in the carriers, since air heated by the DUTs will rise. The conditioned air from thermal controller 24 may have a temperature that is at ambient temperature, above ambient temperature, or below ambient temperature, where ambient temperature may be between 15° Celsius (C.) and 24° C.

Thermal controller 24 may include a chamber, one or more heaters, and/or one or more cooling devices, such as a thermoelectric cooler or convective cooling device. The one or more heaters or one or more cooling devices may change a temperature of air in the chamber, thereby producing conditioned air. Thermal controller 24 may also include one or more fans or other air movement devices to move the conditioned (e.g., heated or cooled) air from the chamber of the thermal controller to interior 12 of enclosure 11 via input port 25 and to move air from the interior 12 of enclosure 11 to thermal controller 24 via output port 26. The resulting air circulation regulates the temperature at the interior 12 of enclosure 11 and, thus, regulates the temperature of the DUTs contained therein. For example, the circulated air may pass over the DUTs contained in enclosure 11, thereby changing their temperature.

Thermal controller 24 may also include one or more humidifiers or dehumidifiers to change the level of humidity of the air in enclosure 11. In some implementations, thermal controller 24, including its housing and all components contained therein, may be is configured to mate to, and to detach from, enclosure 11. This mating and detachment may be performed manually or automatically using robotics that are under control of the control system.

When doors 15 and 19 are closed, and when the connector(s) 21 are connected to electrical and/or optical wiring from test station 22, the combined structure of thermal controller 24 and enclosure 11 is hermetically sealed. That is, the combined structure of thermal controller 24 and enclosure 11 is airtight or substantially air-tight, where substantially air-tight may include minor air leaks, e.g., air leaks on the order of single-digit or tens of milliliters during a testing cycle performed by test system 10.

Enclosure 11, doors 15, 19, connector(s) 21, and thermal controller 24 may also be thermally insulated to enable enclosure 11 to hold a temperature over period of time such as one or more hours or longer. Enclosure 11 may be sufficiently insulated to enable it to maintain a temperature at least long enough to accommodate a test cycle, where a test cycle may include all thermal tests to be performed on DUTs in a carrier.

Enclosure 11 is also configured to complement the temperature control implemented by the thermal controller. For example, enclosure 11 and/or an assembly comprised of enclosure 11 and the thermal controller may have a composition, and may have a mass, that facilitates temperature control of the carriers and DUT(s) contained therein by the thermal controller. In an example, enclosure 11 may be made of a thermal conductor such as stainless steel, may have a mass of about 29.5 kilograms (kg), may have a length of about 1.7 meters (m), may have a width of about 0.4 m, may have a height of about 1.5 m, and may have a total internal surface area of 10.5 square meters (m²). These dimensions may be small enough to facilitate temperature control within a predefined timeframe, but are examples only and different enclosures may have different dimensions than these. For example, each dimension may be 10% larger or smaller than that listed, 20% larger or smaller than that listed, 30% larger or smaller than that listed, and so forth. In other examples, the dimensions may not be proportional to those listed. For example, the length may be 10% larger or smaller than that listed or 20% larger or smaller than that listed, whereas the width may be 30% larger or smaller than that listed or 40% larger or smaller than that listed. For example the mass and/or internal surface area may each be 10% larger or smaller than that listed, 20% larger or smaller than that listed, 30% larger or smaller than that listed, and so forth. Enclosure 11 may be made of other types of metal, such as aluminum or metal alloys, or non-metallic substances such as plastics.

Each carrier 14 is configured to hold one or more DUT(s). For example, each carrier 14 may include slots to hold respective circuit boards, packages, components, or other structures on which system-level thermal testing is to be performed by test system 10. FIG. 6 shows an example of a carrier 14 that may be used in test system 10. Carrier 14 includes an interior 27 for holding one or more DUTs. For example, the interior may hold a rack of circuit boards to be tested by test system 10. Carrier 14 includes one or more electrical or optical connectors 29 to connect to complementary connectors 21 at test site 20. Carrier 14 has an open construction containing various holes 30 therethrough. These holes allow air to pass into and through carrier 14 and thereby affect the temperature of DUT(s) held therein. Carrier may also include a top door 34 to load DUT(s) into the carrier. The door may be automatic or manual.

Carrier 14 also includes two pairs of hooks 31, 32 in this example. Hooks 31, 32 mate to complementary slots or other structures at a test site and transition rack (both of which are described below) within enclosure 11. Hooks 31, 32 are also configured to mate to a gantry system (described below) that is configured to hold the carrier and to move the carrier within enclosure 11. Other implementations of carrier 14 may use structures different than the hooks shown to implement the same functions.

Carrier 14 also includes internal electrical and/or optical wiring (not shown) between the one or more connectors 29 and locations where the DUTs are held in carrier 14, such as the slots mentioned above. The electrical and/or optical wiring routes signals between the DUT(s) and one or more connectors 29.

In some implementations, carrier 14 may be made of a thermally conductive metal such as aluminum, may have a mass of about 4.4 kg, may have a length of about 50.8 cm (centimeters), may have a width of about 35.6 cm, may have a height of about 26.7 cm, and may have an interior surface area of about 8632 cm² (square centimeters). These dimensions are examples only and different carriers may have different dimensions than these. For example, each dimension may be 10% larger or smaller than that listed, 20% larger or smaller than that listed, 30% larger or smaller than that listed, and so forth. In other examples, the dimensions may not be proportional to those listed. For example, the length may be 10% larger or smaller than that listed or 20% larger or smaller than that listed, whereas the width may be 30% larger or smaller than that listed or 40% larger or smaller than that listed. For example the mass and internal surface area may each be 10% larger or smaller than that listed, 20% larger or smaller than that listed, 30% larger or smaller than that listed, and so forth. The carrier may be made of other materials, such as stainless steel, other types of metal, or plastics.

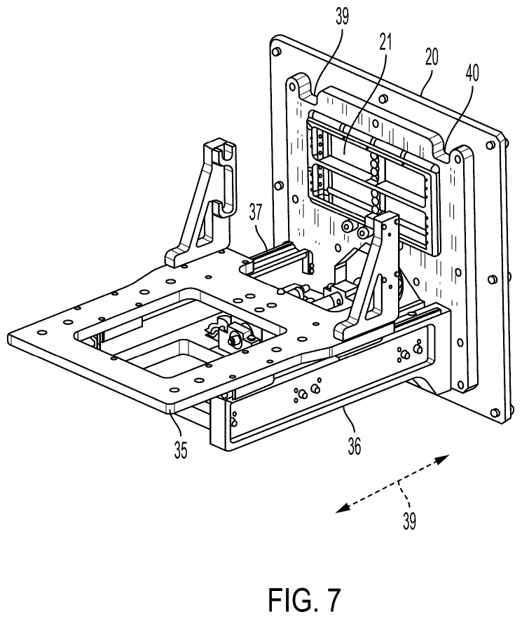

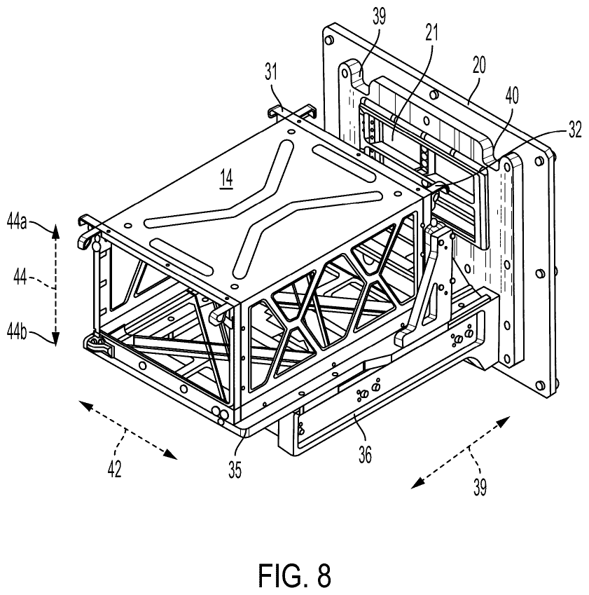

Example test site 20 is shown in FIGS. 7 and 8. FIG. 7 shows test site 20 without a carrier and FIG. 8 shows test site 20 with a carrier 14. One or more connector(s) 29 on carrier 14 mate to one or more connector(s) 21 at test site 20. The one or more connector(s) 21 at test site 20 connect to electrical wires and/or cables and/or optical wires and/or cables (not shown). These electrical wires and/or cables and/or optical wires and/or cables route signals between the DUTs and one or more test instruments at test station 22 that are configured to test the DUTs, as described herein.

Test site 20 includes a shelf 35 configured to move along rails 36, 37, and that is extendible and retractable along the directions of arrow 39. Shelf 35 may be operated using one or more motors or actuators, which may be controlled by the control system to extend and/or to retract the shelf. In some implementations, test site 20 includes roller cam bearings and an interlock. The roller cam bearings and the interlock may facilitate mating of carrier 14 to test site 20. The interlock may include complementary slots or other structures that are part of test site 20 to which hooks 31, 32 mate.

Example interlocks 39, 40 are shown in FIGS. 7 and 8. As shown, hooks 31, 32 are receivable in respective interlocks 39, 40. Shelf 35 may be controlled to move carrier 14 toward the interlocks so that hooks 31, 32 fit within interlocks 39, 40 and thereby hold carrier 14 in place within test site 20 during testing.

Referring to FIG. 8, bearings (not shown), such as roller cam bearings, may be located between shelf 35 and rails 36, 37. The bearings may constrain shelf 35, and thus a carrier 14 on shelf 35, to move along the direction of arrow 39 (the x-axis). The bearings may allow shelf 35, and thus a carrier 14 on shelf 35, to move along the directions of arrow 42 (the y-axis) and along the directions of arrow 44 (the z-axis). This movement is referred to as “floating” since shelf 35, and thus a carrier 14 on shelf 35, are not actively moved in the y-axis and z-axis directions, but rather can move in those direction. For example, this floating allows hooks 31, 32, upon contacting interlocks 39, 40, to move along, over, and into interlocks 39, 40 in the direction 44a of arrow 44 then, following such movement, to be held fast within the interlocks by moving hooks 31, 32 in the direction of arrow 44b of arrow 44. Opposite movements may occur when carrier 14 is disengaged from test site 20. The y-axis and z-axis movement thus may be used for engagement alignment between carrier 14 and test site 20 and to balance shelf 35, and thus carrier 14 on the shelf 35, during movement along rails 36, 37.

Referring to FIGS. 2, 3 and 5, enclosure 11 also contains a load tray 35 to hold carriers containing DUT(s). More specifically, load tray 35 is configured to hold a carrier 14 containing DUT(s) received into enclosure from entry/exit 17 or a carrier containing DUT(s) that have been tested and are to exit enclosure 11 through entry/exit 17.

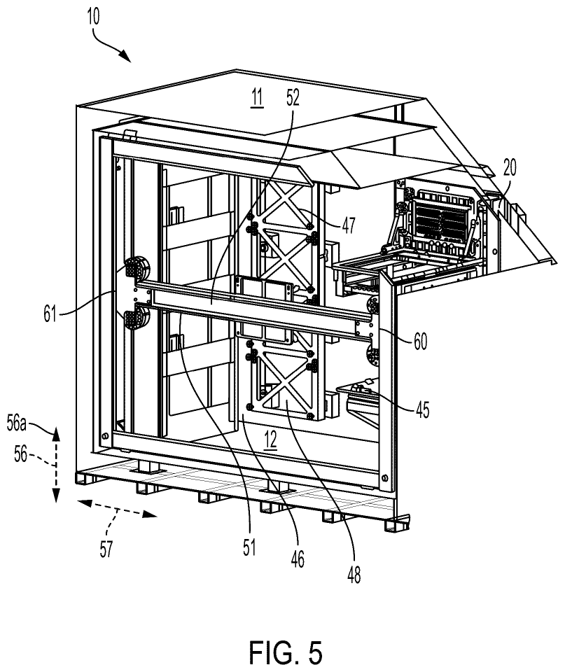

Enclosure 11 contains a transition rack 46. Transition rack 46 is so named because it is the location where the temperature of the carrier and the DUT(s) contained therein transition from an initial temperature, such as ambient temperature, to a target temperature for system-level thermal testing. In some implementations, transition rack 46 may be located at a back wall of enclosure 11 adjacent to thermal controller 24, as shown in FIGS. 2 to 4. In some implementations, transition rack 46 may be located at a side wall of enclosure 11 adjacent to test site 20, as shown in FIG. 5. In either configuration, transition rack 26 may be arranged so that carriers 14 and the DUT(s) contained therein are in thermal communication with thermal controller 24. For example, the carriers and the DUT(s) contained therein may be in the path of circulating cooled or heated air from/to the thermal controller or may simply be subjected to the effects of the circulating cooled or heated air from/to the thermal controller.

In some implementations, transition rack 46 contains multiple slots. In the examples shown, transition rack 46 contains four slots, each configured to mate to, and to hold, a respective carrier 14 containing DUT(s). For example, a carrier 14 may hang from a slot 47 in transition rack 46. In some implementations, there may be fewer than four slots, for example, one, two, or three slots, or more than four slots, for example five, six, seven, or more slots. In some implementations, there may be two or more transition racks within enclosure 11. The number and size of the transition racks may be based on the size of the enclosure and the size of the carriers. The slots in the transition racks may contain holes, such as hole 48 of FIG. 5. These holes promote air circulation, and thus temperature transition, of the carriers and DUT(s) in each slot.

Transition rack 46 may contain one or more temperature sensors (not shown). For example, there may be one or more temperature sensors on each slot 47 that is proximate to a carrier. In some implementations, each carrier may include one or more temperature sensors that are proximate to each DUT. These temperature sensors may report temperature readings of each DUT and/or of the carrier to a control system. In some implementations, the DUTs themselves may report their temperatures to the control system. Based on this information, the control system is able to determine whether each DUT has reached the temperature necessary for one or more system-level thermal tests to be performed by test system 10. The temperature sensors may be wired or wireless temperature sensors that communicate with the control system.

Each slot of transition rack 46 may include an interlock like test site 20 to hold hooks 31, 32 of a carrier 14. Components 49, 50 of carrier 14 (FIG. 6) may also mate to complementary receptacles in a slot 47 of transition rack 46. The carriers dwell in the slots of the transition rack for a duration that is sufficient to control the temperature of the DUT(s) contained in the carrier by allowing the temperature of the DUT(s) to reach a predefined temperature or to be within a predefined temperature range. In this regard, controlling the temperature of the DUT(s) may include decreasing the temperature of the DUT(s) relative to ambient temperature outside of enclosure 11, or increasing the temperature of the DUT(s) relative to ambient temperature outside of enclosure 11. The duration that a given carrier dwells in the transition rack may be set by a control system based on the DUT(s) contained in the carrier, the temperatures to be reached, and the tests to be conducted on the DUT(s) by test instrument(s).

In some implementations, the carriers hanging on transition rack 46 are not flush with the transition rack. For example, when a carrier hangs from a transition rack, there may be at least some space between the part of the carrier facing the transition rack and the transition rack itself. This is so that air can circulate to all surfaces of the carrier and thereby ensure that all DUT(s) contained therein are cooled or cooled relatively evenly. Likewise, there may be space, which may be measured, e.g., in single our double-digit centimeters, between carriers to promote air circulation.

Referring to FIG. 5, enclosure 11 includes a gantry system 51 configured to move a carrier among load tray 45, transition rack 46, and test site 20. Gantry system 51 may be configured to move in three dimensions (3D) within enclosure 11 to pick-up or to place a carrier containing DUT(s) at load tray 35, to move a carrier to or to remove a carrier from transition rack 46, and to move a carrier to or to remove a carrier from test site 20. Operation of gantry system 51, including the components thereof, may be controlled by the control system by controlling operation of one or more motors or actuators associated with gantry system 51 and the components thereof.

In this example, gantry system 51 includes a bar 52 and rails 61, 62, along which bar 52 is configured and controllable to move. Bar 52 is configured and controllable to pick-up and to hold carrier 14. For example, bar 52 may be positioned underneath hooks 31, 32 of a carrier 14 (FIG. 6) and may be configured and controlled to move in the direction 56a of arrow 56 to engage hooks 31, 32 in order to pick-up and hold carrier 14 during movement. One or more motors or actuators may be configured to control movement of bar 52 along rails 60, 61 in response to signals from the control system.

In some implementations, gantry system 51 may include a belt, a pulley, robotics, and/or other mechanism configured and controllable to move the carrier along bar 52 in the directions of arrow 57. One or more motors or actuators may be configured to control movement of the belt, the pulley, the robotics, and/or other mechanism in response to signals from the control system.

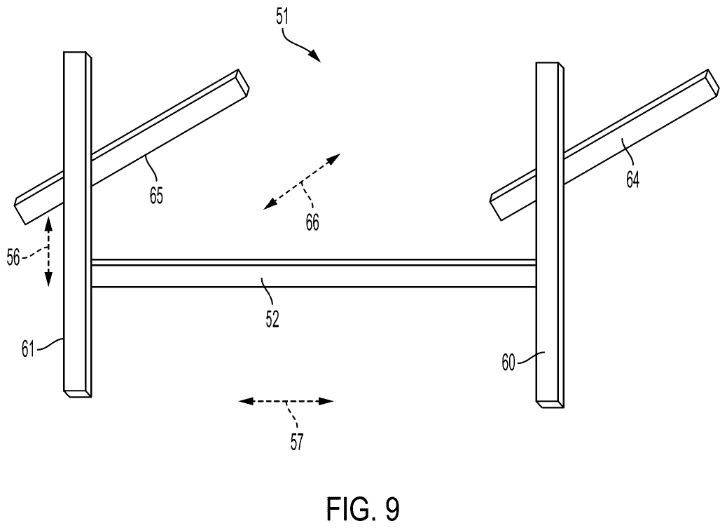

FIG. 9 is a block diagram components of an example implementation of gantry system 51 that may not be visible in the other figures. In addition to the features already described, gantry system 51 may include rails 64, 65 that are perpendicular to rails 60, 61, and along which rails 60, 61 are configured and controllable to move a carrier 14 in the directions of arrow 66 toward or away from the wall of enclosure 11 containing test site 20. This movement enables the gantry system to move a carrier 14 towards or away from test site 20 and, in some implementations, towards or away from a transition rack 46. One or more motors or actuators may be configured to control movement of rails 60, 61 along rails 64, 65 in response to signals from the control system.

In implementations like that of FIG. 5 where transition rack 46 is on a same interior wall of enclosure 11 as test site 20, movement of rails 60, 61 along rails 64, 65 enables the gantry system to move a carrier towards or away from the transition rack. In implementations like those of FIGS. 2 to 4 where transition rack 46 is on an interior wall of enclosure 11 that is adjacent to thermal controller 24, movement of the carrier along bar 51 using a belt, a pulley, robotics, and/or other mechanism enables the gantry system to move a carrier towards or away from the transition rack. The location of transition rack 46 within enclosure 11 may be programmed into the control system and the movement of gantry system controlled based on the location of the transition rack.

Referring to FIG. 2, test system 10 includes a conveyer 66 which may be or include a belt and a motor to run the belt in response to signals from the control system. When door 19 is open, conveyor 66 may be configured to receive a carrier containing DUT(s) and to move the carrier towards entry/exit 17 and towards or onto load tray 45. A two-axis picker robot (not shown), which may be inside or outside of enclosure 11 may be configured, and controllable by the control system, to move the carrier between conveyer 66 and load tray 45—when loading carriers into enclosure 11, from conveyor 66 to load tray 45. The conveyor may be configured and controlled to operate until a predefined number of carriers containing DUT(s) have been loaded into enclosure 11, whereafter door 19 (and door 15, if open) may be controlled to close. The predefined number may be set by the control system. In this regard, in some implementations, each carrier may be assigned an identifier, such as a number, which may be included on the carrier as a bar code or QR (quick response) code. One or more sensors (not shown), which may be part of the control system or in communication with the control system, may detect each carrier as it is loaded onto the conveyer. The control system may keep track of where each carrier is in the test system and of the number of carriers within enclosure 11 based on these sensor readings.

Conveyor 66 is also configured to receive, via entry/exit 17, carriers from enclosure 11 containing DUT(s) that have been tested. These DUTs may similarly be tracked by the control system and removed from the conveyer. The two-axis picker robot may be configured, and controllable by the control system, to move the carrier from load tray 45 to conveyor 66.

In some implementations, robotics, such as a robotic arm or arms containing end effectors such as grippers, may load carriers 14 containing DUT(s) to be tested onto conveyor 66 and remove carriers 14 containing DUT(s) that have been tested from conveyor 66. In some implementations, carriers 14 containing DUT(s) to be tested may be loaded manually onto conveyor 66 and carriers 14 containing DUT(s) that have been tested may be removed manually from conveyor 66.

In some implementations, conveyer 66 and/or the two-axis picker robot may be replaced completely with a robotic arm. For example, the robotic arm may place carriers directly onto load tray 45. An example of a robotic arm that may be used is described in U.S. Pat. No. 11,822,355 titled “Programmable Robot”, the contents of which are incorporated herein by reference. Other types of robotic arms or robots in general may be used in place of that described in U.S. Pat. No. 11,822,355.

In some implementations, conveyer 66 can be removed and carriers may be placed onto load tray 45 manually.

Referring to FIG. 1, test system 10 includes a control system 70 that is that configured—for example, programmed—to perform the operations described herein and to communicate with and to control the various components of test system 10 including, but not limited to, thermal controller 24, gantry system 51, test site 20, robotics to load/unload carriers, doors 15, 19, and conveyor 66. Control system 70 may also be configured to direct and/or to control system-level thermal testing of a DUT via test site 20 using one or more test instruments in test station 22, examples of which are described below. In some implementations, communication 71 with the test instrument(s) and/or the components of test system 10 such as thermal controller 24, gantry system 51, test site 20, robotics to load/unload carriers, doors 15, 19, and conveyor 66 may be over one or more direct connections such as a computer bus or an optical medium. In some implementations, communication with the test instrument(s) and/or the components of test system 10 such as thermal controller 24, gantry system 51, test site 20, robotics to load/unload carriers, doors 15, 19, and conveyor 66 may be over a computer network. The computer network may be or include a local area network (LAN) or a wide area network (WAN). Control system 70 may be configured to provide test programs and/or test signals to the test instrument(s), which the test instrument(s) use to test DUT(s) in a carrier at test site 20. Control system 70 may also be configured to receive DUT response signals (e.g., measurement data) from the test instrument(s) and to determine whether the corresponding DUT has passed or failed testing.

Control system 70 may be or include one or more processing devices 72 (e.g., microprocessor(s)) and memory 74 for storing instructions 75 to execute to control operation of the components of test system 10 and/or testing performed by the test system. Control system 70 may be included within test station 22 or control system may be an external computing system, which may include a stand-alone, distributed, or cloud-based computing system. In some implementations, the control functionality of the control system is centralized in processing device(s) 72. In some implementations, all or part of the control functionality attributed to control system 70 may also or instead be implemented on one or more test instruments in test station 22. For example, the control system functionality may be distributed across processing device(s) 72 and one or more of test instruments contained within the test system. For example, the control system functionality may reside within one test instrument in test station 22 or be distributed across multiple test instruments in test station 22.

Test system 10 includes test station 22. Test station 22 may include one or more test instruments 76, each of which may be configured, as appropriate, to implement testing of DUT(s) in a carrier mated to test site 20. An example test instrument 76 is a hardware device that may include one or more processing devices 77, and memory 79 storing instructions 80 that are executable by the one or more processing devices 77 to perform testing functions. Example test instrument 76 may also include test electronics such as a parametric measurement unit (PMU) and/or pin electronics (PE). Although only one test instrument is shown, test station may include any appropriate number of test instruments, such as two, three, four, or more test instruments, including one or more test instruments residing outside of test station 22. Each test instruments may be configured—for example, programmed—to output test signals to test DUT(s) in a carrier 14 mated to test site 20. The test signals to test the DUT(s) may be or include commands, instructions, data, parameters, variables, test vectors, and/or any other information designed to elicit response(s) from the DUT. Test station 22 may include different types of test instrument(s) such as radio frequency (RF) test instruments to send RF test signals and receive RF response signals, digital test instrument(s) to send digital test signals and receive digital response signals, analog test instrument(s) to send analog test signals and receive analog response signals, and so forth. Any number and type of test instrument may reside within test station 22.

Referring to FIG. 4, or more test channels 81 are configured between test station 22 and test site 20 to enable communication between the DUT(s) in a carrier mated to test site 20 and test instrument(s) 76 in test station 22. Signals such as RF signals, digital signals, or analog signals may be transmitted between the test instrument(s) and the DUT(s) over these test channel(s). The test channel(s) may include one or more wired test channels. The one or more wired test channel(s) may include the electrical wires and/or cables and/or optical wires and/or cables described above, and connectors therefor that mate to respective complementary connectors at test site 20 and at test station 22. In some implementations, the electrical wires and/or cables may include coaxial cables. In some implementations, a test channel may be implemented using one or more transmission lines. In some implementations, a test channel between test instrument 76 in test station 22 and test site 20 is direct and includes no switches, interconnects, or other circuitry to route signals. In some implementations, one or more of the test channel(s) may include one or more wireless test channels. A wireless test channel may be implemented over the air and does not includes wires.

In some implementations, a test instrument 76 in test station 22 is within a range of 0.1 m to 1.5 m of test site 20, although this distance between the two may vary beyond this range. The relative closeness of the test instrument and the test site (and thus the DUT(s) in the carrier mated to the test site) may reduce signal loss between the test instrument and the DUT(s) and thereby improve signal fidelity. For example, in some implementations, a test channel having a length of between 0.1 m and 1.5 m may have a 50% or greater decibel improvement in insertion loss for test signal frequencies up to 40 gigahertz (GHz) than test channels having lengths outside that range.

Another way to reduce signal loss between a test instrument 76 in test station 22 and test site 20, and thereby improve the fidelity of signals transmitted between test instrument 76 and test site 20, may include limiting the number of interconnects on each test channel. An example interconnect is a device configured to create a physical or logical connection between two electronic devices or conduits. In some implementations, the number of interconnects in each test channel is 16 or fewer, 15 or fewer, 14 or fewer, 13 or fewer, 12 or fewer, 11 or fewer, 10 or fewer, 9 or fewer, 8 or fewer, 7 or fewer, 6 or fewer, 5 or fewer, 4 or fewer, 3 or fewer, 2 interconnects, one interconnect, or no interconnects. By limiting the number of interconnects in each test channel, signal loss may be reduced, thereby increasing the signal fidelity between the test instrument and the DUT(s) in the carrier mated to the test site 20. In some implementations, however, there may be more than 16 interconnects in a test channel.

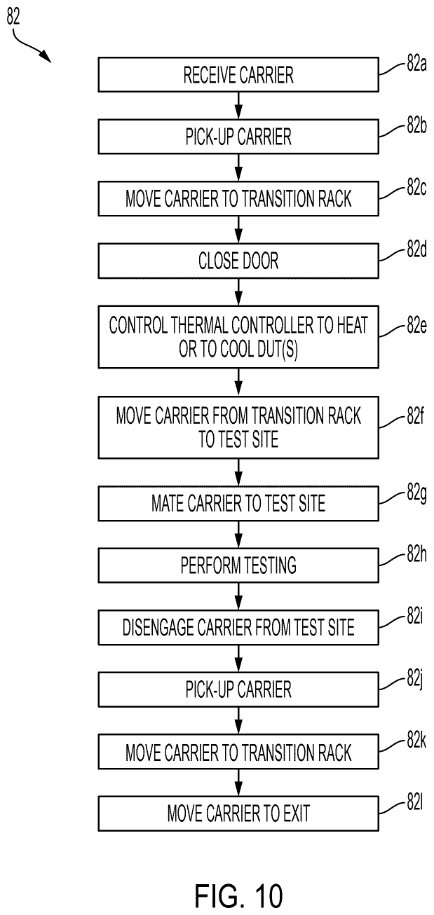

FIG. 10 is a flowchart showing an example process 82 that may be performed on test system 10 to implement system-level thermal testing on one or more DUT(s) held in a carrier 14. Components of test system 10 may be controlled, e.g., by control system 70 to perform the operations included in FIG. 10.

Process 82 includes receiving (82a) a carrier 14 containing one or more DUT(s) into enclosure 11. This may include controlling door 19 to open, controlling a robot to place the carrier onto conveyer 66, controlling conveyer 66 to move the carrier to entry/exit 17, and controlling a pick-and-place robot to move the carrier from the conveyor to load station 45. In some implementations, the carrier may be placed manually onto conveyer 66. Process 82 includes gantry system 51 picking-up (82b) the carrier at the load station and moving (82c) the carrier to transition rack 46. In the meantime, an additional carrier containing one or more DUT(s) may be received. Operations 82a to 82c may be repeated any number of times to load any number of carriers into enclosure 11, with the maximum number of carriers that can be received into enclosure 11 being based on the number of slots in the transition rack, for example. Once all carriers have been loaded into enclosure 11, door 19 is closed (82d), thereby creating an insulated thermal environment with enclosure 11, which may be controlled to be above, below, or at ambient temperature at different times during a testing cycle.

Process 82 includes controlling (82e) thermal controller 24 to heat or to cool the DUTs in the carriers as described herein. The control system receives temperature readings from sensors on a carrier and/or the DUT(s) in the carrier and determines, based on the temperature readings, that the DUT(s) are ready for testing. Process 82 includes controlling gantry system to move (82f) the carrier containing the DUT(s) to test site 20. Process 82 includes controlling gantry system 51 to disengage from the carrier after the carrier is on shelf 35 and controlling shelf 35 to retract to mate (82g) the carrier to test site 20. Process 82 includes controlling a test instrument 76 in test station 22 to perform testing (82h) on DUT(s) in the carrier at the test site over one or more test channels. Following testing, process 82 includes controlling shelf 35 to extend to disengage (82i) carrier 14 from test site 20, controlling gantry system 51 to pick-up (82j) the carrier from the shelf, and controlling gantry system 51 to move (83k) the carrier into a slot in transition rack 46. Operations 82e to 82k may be repeated one time or multiple times for each carrier within enclosure 11 so that DUT(s) in the carrier may be subjected to thermal testing at different temperatures. In this example, following all thermal tests, door 19 is opened, and gantry system 51 is controlled to move (82l) each carrier sequentially to entry/exit 17, where that carrier is removed from enclosure 11.

As noted, in some implementations, the same DUT may be tested at different temperatures, where testing at different temperatures may be controlled by a test program executing on a test instrument. In some implementations, multiple—for example four—carriers each containing one or more DUTs may be loaded into enclosure 11. In some implementations, all DUTs in the enclosure may be subjected to their full battery of system-level thermal tests before any of the carriers containing those DUTs is removed from enclosure 11. For example, four carriers may be loaded into enclosure 11. All thermal testing on those DUTs may be performed before any of the carriers containing those DUTs is removed from enclosure 11. This type of batch testing reduces the amount that door 19 is opened, thereby reducing fluctuations of the temperature within enclosure 11 during testing. In some implementations, an individual carrier containing DUTs may be removed from enclosure immediately following testing performed on the individual carrier.

All or part of the example systems and example processes described in this specification and their various modifications may be configured or controlled at least in part by one or more computers such as control system 70 or a test instrument 76 using one or more computer programs tangibly embodied in one or more information carriers, such as in one or more non-transitory machine-readable storage media. A computer program can be written in any form of programming language, including compiled or interpreted languages, and it can be deployed in any form, including as a stand-alone program or as a circuit, part, subroutine, or other unit suitable for use in a computing environment. A computer program can be deployed to be executed on one computer or on multiple computers at one site or distributed across multiple sites and interconnected by a network.

Actions associated with configuring or controlling the test system and processes described herein can be performed by one or more programmable processors executing one or more computer programs to control or to perform all or some of the operations described herein. All or part of the test systems and processes can be configured or controlled by special purpose logic circuitry, such as, an FPGA (field programmable gate array) and/or an ASIC (application-specific integrated circuit) or embedded microprocessor(s) localized to the instrument hardware.

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer include one or more processors for executing instructions and one or more storage area devices for storing instructions and data. Generally, a computer will also include, or be operatively coupled to receive data from, or transfer data to, or both, one or more machine-readable storage media, such as mass storage devices for storing data, such as magnetic, magneto-optical disks, or optical disks. Non-transitory machine-readable storage media suitable for embodying computer program instructions and data include all forms of non-volatile storage area, including by way of example, semiconductor storage area devices, such as EPROM (erasable programmable read-only memory), EEPROM (electrically erasable programmable read-only memory), and flash storage area devices; magnetic disks, such as internal hard disks or removable disks; magneto-optical disks; and CD-ROM (compact disc read-only memory) and DVD-ROM (digital versatile disc read-only memory).

As used herein, the terms “comprises,” “comprising,” “includes,” “including,” “has,” “having,” “contains,” “containing,” and any variations thereof, are intended to cover a non-exclusive inclusion, such that systems, techniques, apparatus, structures, processes, or other subject matter described or claimed herein that includes, has, or contains an element or list of elements does not include only those elements but can include other elements not expressly listed or inherent to such systems, techniques, apparatus, structures, processes or other subject matter described or claimed herein.

All examples described herein are non-limiting.

In the description and claims provided herein, the adjectives “first”, “second”, “third”, and the like do not designate priority or order unless context suggests otherwise. Instead, these adjectives may be used solely to differentiate the nouns that they modify.

Any mechanical, electrical, or optical connection herein may include a direct physical connection or an indirect connection that includes one or more intervening components. A connection between two electrically conductive components is an electrical connection unless context suggests otherwise. A connection between two optical components is an optical connection unless context suggests otherwise.

Elements of different implementations described may be combined to form other implementations not specifically set forth previously. Elements may be left out of the systems described previously without adversely affecting their operation or the operation of the system in general. Furthermore, various separate elements may be combined into one or more individual elements to perform the functions described in this specification.

Other implementations not specifically described in this specification are also within the scope of the following claims.

What is claimed is:

1. A test system comprising:
a test site configured to mate to a carrier, the carrier containing a device under test (DUT) to be tested at the test site;
a transition rack comprising slots, a slot being configured to mate to the carrier, the transition rack and the carrier mated to the slots being in thermal communication with a thermal controller, the thermal controller for controlling a temperature of the DUT;
a gantry system to move the carrier between the transition rack and the test site;
an enclosure containing the test site, the transition rack, and the gantry system, the enclosure being configured to complement temperature control of the carrier and the DUT contained therein by the thermal controller; and
a test instrument configured to communicate with the DUT in the carrier in the test site to test the DUT.

2. The test system of claim 1, wherein the enclosure and/or an assembly that includes the enclosure comprises a material or has a mass that complements temperature control of the DUT.

3. The test system of claim 1, wherein the test instrument is within a range of 0.1 to 1.5 meters from the test site.

4. The test system of claim 3, wherein the test instrument comprises a test channel between the test instrument and the test site, the test channel comprising a wired or wireless channel and being within the range.

5. The test system of claim 3, wherein the test channel between the test instrument and the test site is direct and includes no switches.

6. The test system of claim 4, wherein, within the range, there is an improvement in insertion loss of 50% or greater for test frequencies of up to 40 gigahertz (GHz).

7. The test system of claim 4, wherein the test channel comprises fewer than sixteen interconnects between the test instrument and the test site.

8. The test system of claim 1, wherein, when mated, the carrier hangs from the slot in the transition rack.

9. The test system of claim 1, wherein the test site comprises:
a shelf to hold the carrier; and
an actuator to extend the shelf to receive the carrier and to retract the shelf to mate the carrier to the test site.

10. The test system of claim 1, wherein the gantry system is configured to move each carrier in three dimensions.

11. The test system of claim 1, further comprising:
a control system configured (i) to control the gantry system to move the carrier from the transition rack to the test site for testing, (ii) to control the gantry system to move the carrier from the test site to the transition rack following testing, (iii) to control the thermal controller to change a temperature of the DUT, and (iv) to control the gantry system to move the carrier from the transition rack to the test site for testing following the change in temperature.

12. The test system of claim 1, wherein the enclosure comprises an input to receive the carrier;
wherein the test system comprises a conveyor to move the carrier relative to the input; and
wherein the gantry system is controllable to move the carrier between the input and the transition rack.

13. The test system of claim 12, further comprising:
robotics to move the carrier to and from the conveyor.

14. The test system of claim 1, further comprising the thermal controller, the thermal controller comprising a convective cooling device or a heating device.

15. The test system of claim 1, wherein the thermal controller is configured to mate to, and to detach from, the enclosure.

16. The test system of claim 1, wherein the test site comprises roller bearings and an interlock, the roller bearings and the interlock for enabling the carrier to mate to the test site.

17. The test system of claim 1, wherein the test instrument is configured to communicate with the DUT over a cable connection, the cable connection including a connector at the enclosure, the connector being insulated and sealed.

18. The test system of claim 1, wherein controlling the temperature comprises decreasing the temperature relative to ambient temperature outside of the enclosure.

19. The test system of claim 1, wherein controlling the temperature comprises increasing the temperature relative to ambient temperature outside of the enclosure.

20. The test system of claim 1, further comprising:
a control system configured to assign each carrier an identifier and to track movement of the carrier throughout the test system based on the identifier.
